(19) United States
(12) Patent Application Publication
(10) Pub. No.: US 2003/0038885 A1
(43) Pub. Date: Feb. 27, 2003

(54) WIDE GAMUT MOTION IMAGE CAPTURE PROCESS FOR POST PRODUCTION APPLICATIONS

(76) Inventor: NESTOR M. RODRIGUEZ, ROCHESTER, NY (US)

Correspondence Address: PATENT LEGAL STAFF, EASTMAN KODAK COMPANY, 343 STATE STREET, ROCHESTER, NY, 14650-2201, US

(21) Appl. No.: 09/082,956

(22) Filed: May 21, 1998

(51) Int. Cl. H04N 5/235

(52) U.S. Cl. 348/222.1; 348/265

(57) ABSTRACT

An electronic image capture system for capturing a sequence of images, the system comprises a camera that captures a sequence of incoming incident light on a sensor and records the sequence of images as wide gamut image data. A processor receives the wide gamut image data and processes the image data to provide a means for making the wide gamut image data compatible with post production systems.

### FIELD OF THE INVENTION

The invention relates generally to the field of electronic capture of motion image sequences and, more particularly, to an electronic motion image capture system which provides a digital record by separating the image capture stage from the image processing.

### BACKGROUND OF THE INVENTION

High quality images for the entertainment industry (theatrical motion pictures, television, special venues, and the like) have been primarily captured by traditional motion picture cameras, or film systems, due to the limitations possessed by video cameras. These limitations result from the video camera's internal processing of the electro-optical sensor image data that conforms it to existing video standards, and causes the image data available for further processing to be bandwidth limited. Therefore, reducing the effective dynamic range and detail of the three color image records captured by the sensor.

When originating with film for television, the images are captured by exposing the film in a motion picture camera (typically at 24 frames per second—although not limited to this frame rate), and subsequently, chemically processing the film. Film products are able to capture a wide exposure latitude or dynamic range of contrast in a scene. Details in the shadows or dark areas of a scene, plus the details of highlights or bright areas are captured well by film. In shooting (exposing) film, the cinematographer understands the latitude of film and uses lighting to make best usage of that latitude. This whole process of capturing a wide latitude record and subsequently processing it in post-production is a significant advantage of film origination over video originated systems. Another factor is film's ability to maintain image detail in the extremes of the dynamic range which can be recovered should the film be incorrectly exposed, or if factors in the scene cannot be controlled, such as those in which scene content includes both bright highlights (e.g. detail in a white satin dress) and shadows (e.g. detail in dark wood).

Video systems (that is, traditional prior art electronic motion image capture systems), on the other hand, have a more limited dynamic range or contrast ratio. Video camera systems and associated recording/transmission systems only manage a narrow contrast ratio. Often image color detail in dark shadows and/or bright highlights is lost (“crushed” blacks and/or “clipped highlights”) by the video process. This limited dynamic range is no longer necessarily a result of video camera and recording technology, however. Rather, the present inventions have recognized that the limitations are imposed by requiring the recording signal color metric to be “TV display ready” or “rendered” for the TV display.

When images are captured using a video camera (which captures/processes a motion image electrical signal) and recorder, the system is designed to process the signals and provide a finished image within the bandwidth limitations of a specific television/video standard (which is inherent in the design of the particular camera-recorder system, for example ITU-R Rec. 601-3, ANSI/SMPTE 274M-1995, etc.). In addition to the processing implemented to meet the signal/recording requirements of a specified video standard, video cameras also provide various types of controls to achieve the image “look” desired by a user. In a simple camera, this may just be white balance. Other controls such as brightness (exposure), gamma (contrast), and color matrixing could also be provided. Some sophisticated cameras may provide a range of “knee” point/slope settings (tone scale manipulation), filtering and various image processing controls to adjust the image being recorded. However, all these adjustments must be made on the camera before the images are captured, and are of a “trial-and-error” type. Image quality, therefore, relies on the user's knowledge and experience.

In practice, the image recorded by the video camera systems is recorded to a defined video display standard, and as such, contains less image information capacity relative to what is captured by the video camera sensors. Factors in the design and specification of these video standards (gamma correction, color sub-sampling, compression, etc.) result in the amount of image information available for creating special effects, theatrical images—and even television—being relatively limited. Often, after capturing the video images, the users may wish to modify the images with post-production tools. The range of adjustments that can be made to the video originated images is limited since the color metric used to record the video signals at the time of image capture is rendered for the TV display. Thus, the creativity gamut of this process is considerably less than available using film originated images. Since video standards are also not compatible with each other (component vs. composite video, NTSC vs. PAL, standard versus digital high definition, etc.), the quality of the images produced when converting from a lower to a higher order video standard/format results in a lower quality image (e.g. artifacts).

While the sensors inside a digital video camera are generally able to capture a wide dynamic range (some approaching the dynamic range/resolution of negative film), this is reduced by the processing in the camera down to a range that can be recorded in a standard video format signal (e.g. ITU-R Rec. 601-3). Various user controls, internal setups, automatic functions and processing occur to scale the range of image information the sensor captures down to the image extent of the specific video format (standard) to be recorded/transmitted. These operations can include black and white level clamping or clipping, gamma adjustments, white balancing, “knee” adjustments and more. Even when these operations are performed in the digital video domain, the amount of image information available for creative manipulation or producing high quality images (e.g. theatrical motion pictures) recorded with a digital camera (whether analog or digital) is limited relative to what is achievable with film.

It would be desirable then to provide a means, by which original scenes can be captured using electronic digital motion cameras as an alternative to video, to simulate the imaging benefits produced with a traditional motion picture camera/film/processor system. Capturing the image information in a “data-type” format, independent of any particular video format/standard, would also allow for the same type of compatibility encountered when converting film images to any video format, as well as flexibility when transferring to other imaging media requiring a higher level of image fidelity (e.g. theatrical film images) than is currently available from any digital video technology. In addition, it would be desirable to provide a means that would allow for the application of functions/algorithms to manipulate the captured wide gamut image data to produce a digital image record having the attributes/appearance desired by the user. The image data record produced by applying the present invention could then be manipulated for “creative effects” by currently utilized post-production tools (e.g. image processing computer workstation) employed with motion images captured on film.

### SUMMARY OF THE INVENTION

The present invention is directed to overcoming one or more of the problems set forth above. Briefly summarized, according to one aspect of the present invention, the invention resides in an electronic image capture system for capturing a sequence of images, the system comprising: (a) a camera that captures a sequence of incoming incident light on a sensor and records the sequence of images as wide gamut image data; and (b) a processor that receives the wide gamut image data and processes the image data to provide a means for making the wide gamut image data compatible with post production systems.

It is an object of the present invention to provide post production systems with images captured/recorded with wide gamut image information even though this type of wide gamut image information would not initially include all the attributes necessary to render the image on a display device.

The above and other objects of the present invention will become more apparent when taken in conjunction with the following description and drawings wherein identical reference numerals have been used, where possible, to designate identical elements that are common to the figures.

### ADVANTAGES OF THE PRESENT INVENTION

The invention described here implements a two-stage motion image capture process that has the advantage of providing additional (wide gamut) image information to do post-production operations. This is unlike the image information captured/recorded by video camera systems who as a result of their video processing to render images ready for television display, reduce the gamut that can be captured by video camera sensor(s).

There are post-production applications which would benefit by employing as source material, images captured/recorded with wide gamut information even though this type of wide gamut image information would not initially include all the attributes necessary to render the image on a display device (refer to commonly assigned U.S. Patent Application No.______, filed May 21, 1998 entitled “Multi-Stage Electronic Motion Image Capture and Processing System”). This type of wide gamut image record would still, however, supply more descriptive information about the constituents that make up the images—in addition to being less susceptible to the type of image quality degradation resulting in the process of converting one video image standard format to another—when compared to the TV display ready images generated by video cameras, whose images are produced with a lower gamut as a result of the camera/recorder video processing operations that exist in prior art. A type of “working” image record containing wide gamut image data, in these cases, would be sufficient to accomplish the post-production applications; and where the necessary image transforms to render the images ready for a display could also be applied as part of the image processing performed in the post-production system (e.g. Kodak Cineon Digital Film System). For these applications, the user might prefer to by-pass the operations/algorithms applied by the Photoscience Image Processor (PIP) described in the second stage of commonly assigned U.S. Patent Application Serial No.______, filed May 21, 1998 entitled “Multi-Stage Electronic Motion Image Capture and Processing System”, and instead, directly acquire the wide gamut image data record from the motion image capture stage (camera) to perform alternative proprietary image processing that benefits from the use of wide gamut-type image information to develop or create a desired image. The image record produced by the first camera stage would then need to be converted/structured to allow it to be compatible with the selected post-production system.

### BRIEF DESCRIPTION OF THE DRAWINGS

FIG. 1 is a camera of the present invention for capturing a sequence of incident images; and

FIG. 2 is a block diagram illustrating the process of the present invention.

### DETAILED DESCRIPTION OF THE INVENTION

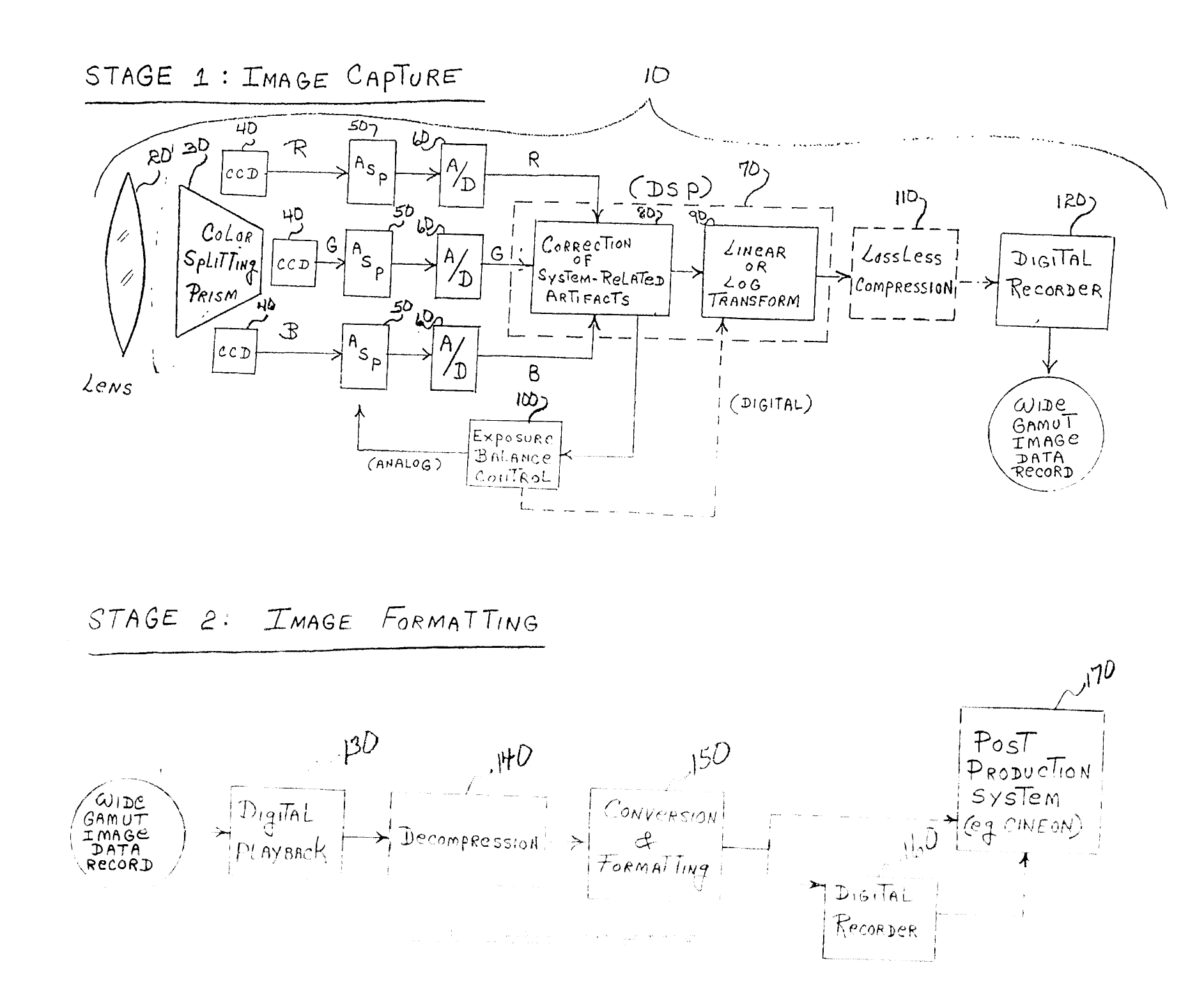

Referring to FIG. 1, there is illustrated a digital “data” camera 10 of the present invention, hereinafter referred to as a datacam, having a lens 20 for permitting ambient light to enter the camera 10 and a color splitting prism 30 for dividing the light into three separate red, green and blue (RGB) components, although those skilled in the art will recognize that other devices for separating the light into three color components may be used. Depending on the sensor's spectral characteristics, additional optical filtering may be added to achieve minimal electronic/digital gain for a specified white illuminant and to reduce aliasing (due to a sensor's spatial sampling geometry). Three photoelectric-type sensors 40 (preferably a charge-coupled device or CCD) each for receiving a particular color component as separated (filtered) by the color splitting prism 30, and then for respectively converting the particular color component into an electronic signal. Each sensor 40 preferably uses the same spatial resolution (the number of pixels per sensor). The absolute light sensitivity and dynamic range of the combined lens system (20), optical prism/filters (30) and sensors (40)—or any other light balancing filters—is to be comparable in magnitude to photographic film systems in terms of speed and exposure latitude; and the spatial resolution of the sensor to be sufficient for the user application. It is instructive to note that, if the color splitting prism is removed, a single sensor with a well known color-filtered array superimposed and in registration with the pixels may be used to accomplish the function composed of the above-described prism and sensor combination. It also facilitates understanding to note that more than three sensors 40 may be used, and that other color channels, different in number and color, may also be used as those skilled in the art will readily recognize. The image data will be captured at a predetermined rate (e.g. 24 frames per second) by implementing any suitable technique to control the rate/time interval at which the sensor system gathers/integrates light (e.g. synchronized shutter).

Three analog signal processors (ASP) 50 respectively receive the electronic signal from the CCDs 40 for performing a plurality of processing functions on the analog signals, such as channel amplification, gain , etc. Three analog to digital (A/D) converters 60 respectively receive the signals from the ASPs for converting each signal into digital form. A digital signal processor (DSP) 70 receives all of the signals from the A/D converters 60 for performing a plurality of processing functions on the received digital signals, such as to modify the image information to reduce artifacts 80 (filtering to prevent aliasing), and to reduce electronic noise originating in the camera's components (the fixed pattern noise correction applied to sensor-type arrays-to eliminate the nonimage-related spurious signals associated with dark current and sensitivity difference between pixels). Additional signal processing (to linearize and/or optimally distribute the coded values in the analog to digital conversion) is performed by a linear or log transform 90 so that the RGB digital data is related to the light intensity measured by the sensor by a mathematical linear, log or power transfer function. Some of the operations described by the analog signal processor 50 could alternatively be done by the digital signal processor 70 or vice versa as those skilled in the art will recognize. An exposure balance controller 100 receives all three signals from the digital signal processor 70 and performs a white balance operation (i.e. signals are made equivalent for a particular white light source). This processing can be implemented by the ASP 50 (as illustrated by the solid line) or DSP 70 (as illustrated by the dashed line).

Optional data compression can be done after the DSP 70 operation as indicated by the lossless compressor 110. The data is then stored by a digital recorder 120 on some medium, such as magnetic tape, disc, and the like, as wide gamut image data. Wide gamut image data is defined as the data captured by the three independent red, green and blue sensors 40, which has not been reduced in scope as a result of the type of processing that occurs in the prior art to render the image data compatible for V display (or a standard video format). It is understood that using current technology such processing associated with artifact correction 80, transform 90 and compression 10 is only needed due to the limitations of existing technology, and that with technological advances such processing would be unnecessary. It facilitates understanding to note that the wide gamut data is dependent upon the dynamic range, spectral responsitivity, and spatial resolution of the sensor in combination with the spectral transmittance bandpass of the three color beam splitters (for example see commonly assigned U.S. Pat. No. 4,994,901).

Referring to FIG. 2, after the images are recorded by the above-described process, the images are then processed. In this regard, the wide gamut image data s retrieved from the storage media by a playback device 130 and, if the data was originally compressed, it is sent to decompressor 140 for decompressing. Obviously, if the data was not originally compressed, this step is bypassed. The image record produced is input to a processor 150 which converts/structures the image data record into an image data format compatible with the post-production system that will import/read the image data. The wide gamut image record, for example, could be configured into a video-type digital record (e.g. Y, Cr, Cb), a digital image file (e.g. SMPTE DPX), etc. The modified image record is then stored on a suitable medium by a digital recorder 160 or transmitted via an output interface 170 (e.g. fibre channel) directly to a post production system. The post-production system, as defined herein, means any system having hardware and/or software that can apply currently available and/or proprietary image processing functions/algorithms to image data, to create (or customize the desired visual attributes in an image, in this case, the wide gamut image data.

The invention has been described with reference to a preferred embodiment. However, it will be appreciated that variations and modifications can be effected by a person of ordinary skill in the art without departing from the scope of the invention. For example, standard dual-channel digital audio and SMPTE time code may be recorded along with the image data.

What is claimed is:

1. An electronic image capture system for capturing a sequence of images, the system comprising:
(a) a camera that captures a sequence of incoming incident light on a sensor and records the sequence of images as wide gamut image data; and
(b) a processor that receives the wide gamut image data and processes the image data to provide a means for making the wide gamut image data compatible with post production systems.

2. The electronic image capture system as in claim 1, wherein the sensor is a charge-coupled device which captures the incoming incident images.

3. The electronic image capture system as in claim 1 further comprising means for converting the sensor data to some other form of linear or logarithmic image data.

4. The electronic image capture system as in claim 1 further comprising a storage medium for storing the wide gamut from the sensor.

5. The electronic image capture system as in claim 4 further comprising a lossless data compression stage prior to recording.

6. The electronic image capture system as in claim 5 further comprising an exposure control for performing exposure control on the signals from the sensor before storage on the storage medium.

7. A method for capturing a sequence of images, the method comprising the steps of:
(a) capturing a sequence of incoming incident image data on a sensor of the camera and for recording the sequence of images as wide gamut image data; and
(b) receiving the wide gamut image data and processing the data to provide a means for making the wide gamut image data compatible with post production systems.

8. The method as in claim 7, wherein step (a) includes capturing the images on a charge-coupled device.

9. The method as in claim 7 further comprising converting the sensor date to some other form of linear or logarithmic image data.

10. The method as in claim 7 further comprising providing a storage medium for storing the wide gamut from the sensor.

11. The method as in claim 10 further comprising providing a lossless data compression stage prior to recording.

12. The method as in claim 11 further comprising providing an exposure control for performing exposure control on the signals from the sensor before storage on the storage medium.
